(19) United States
(12) Patent Application Publication
(10) Pub. No.: US 2020/0261919 A1
(43) Pub. Date: Aug. 20, 2020

(54) SYSTEM FOR PROCESSING AN AGRICULTURAL WASTE BIOMASS PRODUCT INTO A GRINDED PRODUCT

(71) Applicant: Advanced Substrate Technologies A/S

(72) Inventors: Svend Hoff, Odder (DK); Geert Haugaard Olesen, Haderslev (DK)

(73) Assignee: Advanced Substrate Technologies A/S, Assentoft, Randers SO (DK)

(21) Appl. No.: 16/647,262

(22) PCT Filed: Sep. 13, 2018
(86) PCT No.: PCT/EP2018/074776

§ 371 Date: Mar. 13, 2020

(30) Foreign Application Priority Data
Sep. 14, 2017 (EP) 17191185.2

(51) Int. Cl. B02C 19/22; B02C 21/02; B02C 23/02; C10L 5/44

(52) U.S. Cl. CPC B02C 19/22; B02C 21/02; B02C 23/02; C10L 5/442; C10L 2250/06; C10L 2290/28; C10L 2200/0469; C10L 2290/24; C10L 2290/567; C10L 5/445

(57) ABSTRACT

A system for processing an agricultural waste biomass product into grinded product includes a cutting and mixing unit configured for cutting and mixing harvested biomass to a first uniform size and blend and a grinder unit configured for cutting biomass to a second uniform size. The cutting and mixing unit is in fluid communication with the grinder unit through a first transport unit configured for transporting the biomass from the cutting and mixing unit to the grinder unit.

### CROSS-REFERENCE TO RELATED APPLICATIONS

This application is the U.S. national stage of PCT/EP2018/074776 filed Sep. 13, 2018, which claims priority of European Patent Application 17191185.2 filed Sep. 14, 2017 both of which are hereby incorporated by reference in their entirety.

### FIELD OF INVENTION

The present invention relates to a system for processing an agricultural waste biomass product into a grinded product.

### BACKGROUND OF INVENTION

Recently biomass has become increasingly in demand. Biomass may play a key role when replacing fossil energy sources with renewable energy sources. The biomass may be converted into solid fuel such as pellets, liquid fuels, and biogas that are direct substitutes of the fossil based fuels. Further, the biomass may be converted into products that can be used for human or animal nutrition or as fertilizers, or growing medium, for plants, such as substrates for mushrooms, and protein extracts from grass.

A major disadvantage with biomass is the initial transport logistics from the production site, e.g. the field, farm or the stable, to the storage or the plant, and the associated susceptibility to weather conditions. For example litter from animals or harvested cut straw may be spread across the field to dry before it is suitable for collection, storage, and/or transport.

Further, harvested biomass crop has irregular shapes, sizes, compaction, and a high volume, and a low energy density. Thus, after harvesting it is necessary to gather or collect, the harvested biomass, and optionally to further cut and/or compact the material into harvest units with sizes and compaction that is suitable for storage, transportation and/or further processing. By the term “harvest unit” is meant harvested crops that have been collected into a more concentrated bulk, in contrast to the original harvested crops. For example harvested straw may be subjecting to baling, where the baling compresses, or densifies, the straw, and the bales constitute harvest units that are easier, or easily transported and stored, thereby improving the logistics.

When biomass is used as feed stock in a biogas plant, it is further essential that the biomass has a size and shape that facilitate the chemical conversion of the biomass to biofuel. For example, it may be essential that the biomass feed stock have a small and uniform size, and is compacted in such a degree that the surface area of the feed stock is sufficiently exposed for the chemical reactions to occur.

Thus, after harvesting, collection, and/or transport of the harvest units or biomass waste, the biomass is typically cut to sizes suitable for chemical treatment. The cutting is conventionally carried out in a chopper followed by a hammermill.

Harvested biomass and other types of agricultural waste products are particularly susceptible to the weather conditions, since the first collection and storage steps are outdoor. As is known from conventional agriculture, wet biomass is susceptible to rot and degradation of the biomass sugars. In addition, wet biomass is problematic to process in a hammermill, and use of wet biomass in biofuel conversion systems are known to increase the risk of clogged pipes, and floating layers i.e. inefficient material transport in the system. Thus, harvested wet biomass and other types of wet agricultural waste products are typically lost, or alternatively, an additional drying step is essential before storage and/or use, thus further complicating the logistics.

There is therefore a need for systems that can decrease the loss associated with wet biomass, such as wet harvested biomass and other types of agricultural waste products. Further, there is a need for systems that can improve the biomass logistics, and make biomass harvesting less susceptible to weather conditions.

### SUMMARY OF INVENTION

The present disclosure provides a system that may decrease the biomass loss associated with wet biomass. Thus, the present disclosure provides a more efficient biomass production. Further, the system may improve the biomass logistics, and make biomass harvesting less susceptible to weather conditions. The provided system may further improve logistics by being used as a stationary or mobile or moveable system.

By the term “mobile” or “moveable” is meant that the system may be self-propelled and/or trailed by e.g. a tractor.

The present disclosure provides a system for processing any types of agricultural waste products into a grinded product, where the grinded product is suitable as a substrate, or feed stock, for biogas, and/or as a primary growth media for production of plants, such as vegetables production and/or mushroom production.

Examples of agricultural waste products include harvested biomass, such as straw, grass, low quality grass silage, compromised hay, deep litter from e.g. poultry, cattle, and horses, leaves and smaller branches, feather from poultry, and any combinations thereof. Preferably, the biomass is organic or eco-friendly biomass, such as rice straw, elephant grass, e.g. pennisetum purpureum, saccharum ravennae, miscanthus fuscus, and biomass from willow trees. Eco-friendly biomasses are plants providing an environmental improvement to the surroundings, e.g. by attracting, collecting and/or concentrating nutrients into the plant surroundings.

A first aspect of the invention relates to a system 100 for processing an agricultural waste biomass product into a grinded product, comprising:
a cutting and mixing unit 6 configured for cutting and mixing harvested biomass to a first uniform size and blend,
a grinder unit 9 configured for cutting biomass to a second uniform size,
   wherein the cutting and mixing unit is in fluid communication with the grinder unit through a first transport unit 7 configured for transporting the biomass from the cutting and mixing unit to the grinder unit.

A second aspect of the invention relates to a method for processing an agricultural waste biomass product into a grinded product, comprising the steps of:
providing a harvested agricultural waste biomass,
cutting and mixing the biomass into a first uniform size and blend within a cutting and mixing unit 6 configured for cutting and mixing harvested biomass to a first uniform size and blend,
grinding the cut and mixed biomass into a second uniform size within a grinder unit 9 configured for cutting biomass to a second uniform size,
   whereby a grinded product suitable as a substrate for a biogas plant and/or as primary growth substrate for a plant, such as mushroom, and/or as substrate for producing green protein extract.

In a preferred embodiment, the agricultural waste biomass is selected from the group of: straw, grass, low quality grass silage, compromised hay, deep litter from poultry, cattle, and/or horses, leaves and smaller branches, feather from poultry, and any combinations thereof. In a further preferred embodiment, the biomass is selected from the group of organic or eco-friendly biomass, such as rice straw, elephant grass, e.g. pennisetum purpureum, saccharum ravennae, miscanthus fuscus, and biomass from willow trees.

In another preferred embodiment, the second uniform size is smaller than the first uniform size. By the term “uniform size” is meant a size distribution with a narrow size distribution, such as a distribution where 95% or 85% of the sizes are within 5, 10, 20, 30, 40, or 50% of the average size. In a further embodiment, the second uniform size corresponds to a diameter between 1 to 40 mm, more preferably between 6 to 24 mm, and most preferably between 12 to 16 mm.

In another preferred embodiment, the method according to the second aspect of the invention is carried out within the system according to the first aspect of the invention. For example, the steps comprising the cutting and mixing unit and the grinder unit are carried out within the system according to the first aspect of the invention. Thus, the cutting and mixing unit and the grinder unit of the method, are comprised within the system according to the first aspect of the invention.

A third aspect of the invention relates to the use of the system according to the first aspect for processing an agricultural waste biomass product into a grinded product, suitable for a substrate for a biogas plant and/or as primary growth substrate for a plant, such as mushroom, and/or as substrate for producing green protein extract.

A fourth aspect of the invention relates to the use of the system according to the first aspect as feedstock unit for one or more a biogas plant(s).

### DESCRIPTION OF DRAWINGS

The invention will in the following be described in greater detail with reference to the accompanying drawings.

FIG. 1 shows an embodiment of a system 100 for processing agricultural waste product biomass directly into a grinded product, as seen from the top.

FIG. 2 shows an embodiment of a system 100 for processing agricultural waste product biomass directly into a grinded product, as seen in profile.

FIG. 3 shows an embodiment of a grinder unit according to the present invention, and a grinded product exemplified as wood chips.

FIG. 4 shows an embodiment of a cutting and mixing unit, comprising two oppositely rotating screws.

FIG. 5 shows an embodiment of cutting and mixing unit of the type chopper and mixer from the Italian company SEKO, which is a Chopping-Mixing-Wagon from the Samurai 5 series.

FIG. 6 shows an embodiment of a trailed cutting and mixing unit.

FIG. 7 shows an embodiment of a transport unit configured for separating a liquid product from a solid product, such as a grinded biomass product. The embodiment shows a single screw press for separation of fresh cuttet grass, grinded grass, or other types of biomass into a liquid fraction, or juice fraction, and a fiber fraction, or press cake fraction. (A) shows the part of the screw press where biomass is fed in from the grinder unit and (B) shows the part of the screw press where the fiber or press cake exit the screw press unit with a dry matter content of up to 35%.

FIG. 8 shows an embodiment of a transport unit configured for separating a liquid product from a solid product, such as a grinded biomass product. The embodiment shows a twin screw press for separation of fresh cuttet grass, grinded grass, or other types of biomass into a liquid fraction or juice and a fiber fraction or press cake, where the fiber or press cake exit the twin screw press with a dry matter content of up to 50 wt %. (A) shows a twin screw press unit seen from outside, (B) shows the two screws having opposite rotation directions, where one is turning left and the other is turning right, and (C) shows the filter with holes for elimation of the juice.

FIG. 9 shows an embodiment of a biogas plant, where the grinded product from e.g. a mobile or stationary system according to the invention is transferred to the nitrogen steamer unit (indicated as “N-steamer”).

FIG. 10 shows an embodiment of a moveable system 100 for processing harvested biomass into a grinded product. In the embodiment, the harvested biomass is temporary stored 1 on e.g. a field or farm, and the operation of the mobile system, including the grinding, takes place on the location, where the harvested biomass is temporary stored 1 on e.g. the farm.

FIG. 11 shows a further detailed embodiment of a moveable system 100 from a top view.

FIG. 12 shows an embodiment of the moveable system 100 from a side view.

FIG. 13 shows an embodiment of a stationary system 100 according to the present invention.

FIG. 14 shows an embodiment of the moveable system 100 according to the present invention, in fluid communication with one or more biogas plants 17.

FIG. 15 shows an embodiment of the invention, where the system 100 is a stationary unit, optionally directly connected to a biogas plant 17.

FIG. 16 shows an embodiment of the moveable system according to the present invention, adapted for processing fresh to grass juice for green protein production.

### DETAILED DESCRIPTION OF THE INVENTION

The invention is described below with the help of the accompanying figures. It would be appreciated by the people skilled in the art that same feature of component of the device are referred with the same reference numeral in different figures. A list of the reference numbers can be found at the end of the detailed description section.

By the term “agricultural waste products” is meant harvested biomass, such as straw, grass, low quality grass silage, compromised hay, deep litter from e.g. poultry, cattle, and horses, leaves and smaller branches, feather from poultry, and any combinations thereof. Further examples of agricultural waste products are plants or biomass selected from the group of organic or eco-friendly biomass, such as rice straw, elephant grass, e.g. pennisetum purpureum, saccharum ravennae, miscanthus fuscus, and biomass from willow trees.

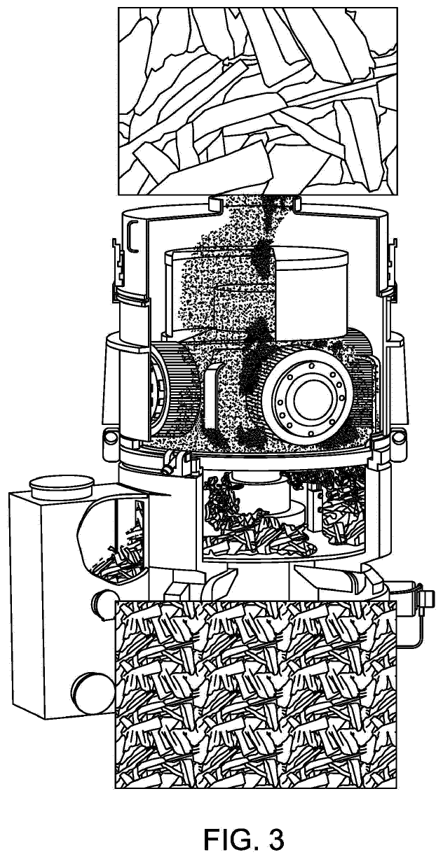

Agricultural waste products, such as harvested straw or litter from animals, are typically collected and coarsely processed, i.e. e.g. coarsely cut, mixed, and or compacted, at the production site, i.e. the field, stable or farm, to make it suitable for particularly transport. After transport to a storage site, the collected biomass is further processed to make it suitable for storage, conversion into biofuel, and/or conversion into biomass products, such as growth media. An example of a further processed biomass that is suitable for storage, conversion into biofuel, and/or conversion into biomass products is a grinded product. By the term “grinded product” is meant biomass constituting of small and uniform pieces, such as wood chips as illustrated in FIG. 3. The further processing may include steps such as further drying, cutting, mixing, and/or compaction. For example, grinded biomass is suitable for conversion into biofuel.

The present invention provides a more efficient and compact system for processing the agricultural waste biomass product from the production site and directly into the products suitable for storage, biofuel, and/or biomass products. Thus, the present invention provides a more simple system for processing agricultural waste products, such as a system where the transport logistics are simplified.

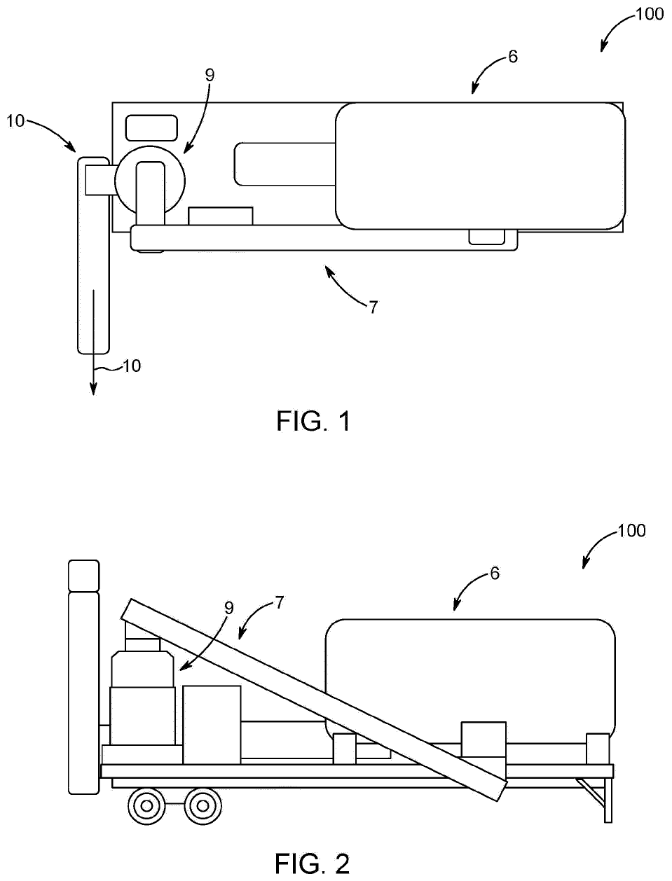

FIGS. 1 and 2 show an embodiment of a system 100 for processing agricultural waste product biomass directly into a grinded product. The agricultural waste product is first subjected to a cutting and mixing unit 6, where the waste product is mixed and cut to a first uniform size and blend. The cut and mixed waste product is then transferred via a first transport unit 7 to a grinder unit 9, where it is converted into a grinded product, having a second uniform size that is finer in size than the first uniform size, and which optionally is further mixed and packed.

### Cutting and Mixing Unit

The cutting and mixing unit is configured for cutting and mixing agricultural waste products in the raw initial form, such as straw, bales, grass, low quality grass silage, compromised hay, and litter from animals. For example, the cutting and mixing unit may be configured for cutting and mixing agricultural waste products of organic or eco-friendly biomass in the raw initial form, such as rice straw, elephant grass, e.g. pennisetum purpureum, saccharum ravennae, miscanthus fuscus, and parts from willow trees.

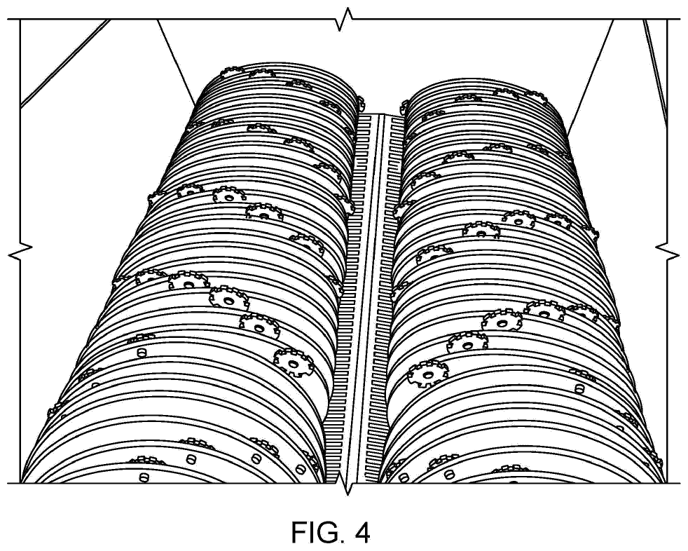

An example of a cutting and mixing unit and the operational principle is shown in FIG. 4. FIG. 4 shows how the cutting and mixing mechanism is based on two rotating snecks, or screws, with knifes. The snecks are rotating slowly, and in opposite directions, e.g. one sneck is turning left and the other right. This facilitates that the waste product, or biomass, entering the cutting and mixing unit is mixed and at the same time the knifes will cut it in smaller pieces.

Advantageously, the cutting and mixing unit is working as a semi-batch process, such that the time for mixing and cutting may be sufficiently controlled before the biomass is further transferred to the grinder.

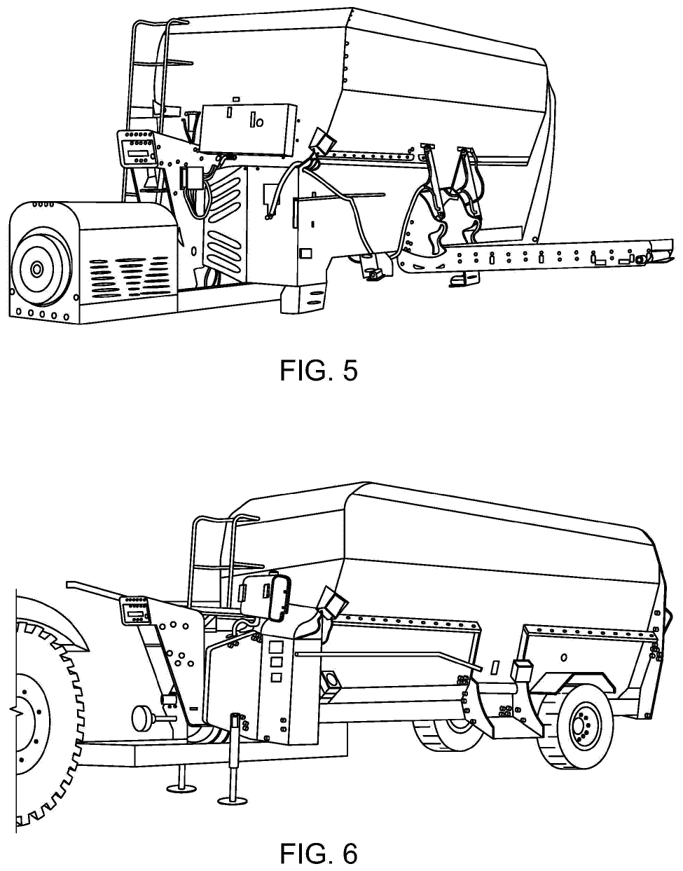

An example of a cutting and mixing unit, or a collection unit is a chopper, or a chopper and mixer, as illustrated in FIG. 5. The exemplified chopper and mixer is from the Italian company SEKO, and is a Chopping-Mixing-Wagon from the Samurai 5 series.

The type of cutting and mixing unit affects the degree and quality of the cutting and mixing of the harvested biomass, and thus, the resulting first uniform size and blend of the biomass after the cutting and mixing unit. A first uniform size and blend that is advantageous as feedstock for a grinder unit, may be obtained with a cutting and mixing based on rotating screws, such as the chopper and mixer.

In an embodiment of the invention, the cutting and mixing unit comprises two rotating screws, wherein the screws are configured to rotate in opposite directions, and preferably the cutting and mixing unit is selected from the group of chopper and chopper and mixer.

The chopper and mixer is conventionally used for forages, such as straw and coarse fodder for dairy cows, fattening cattle, and sheep-and-goat livestock, as well as other types of fibrous products. The coarse fodder may for example include: beets, ensilage, grass, grass silages, corn, maize, and baled or loose straw.

Advantageously, a chopper and mixer has a volume capacity, such as from 5 to 30 m³, whereby it may be adapted for being moveable, e.g. self-propelled or operated trailed, or stationary operation. FIG. 5 shows an embodiment of a stationary collection unit, and FIG. 6 a trailed version, where the collection unit is attached to a truck body. A moveable, or mobile, and self-propelled version can further be obtained by including an electric motor.

In an embodiment of the invention, the cutting and mixing unit has a volume capacity between 1 to 50 m³, more preferably between 3 to 40 m³, or 10 to 20 m³, and most preferably is from 5 to 30 or 5 to 33 m³.

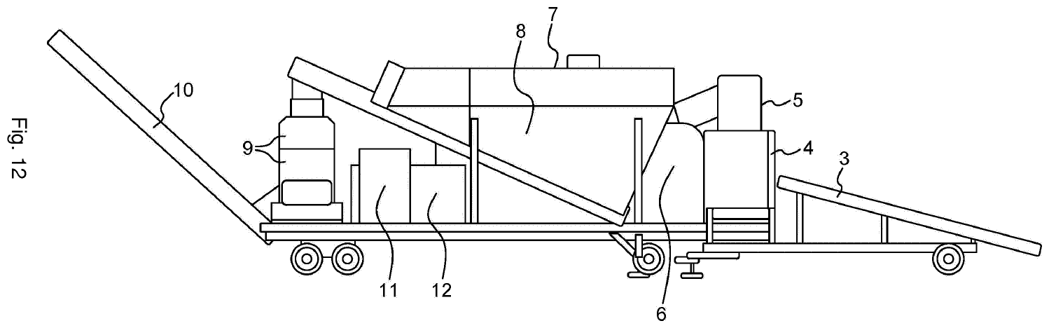

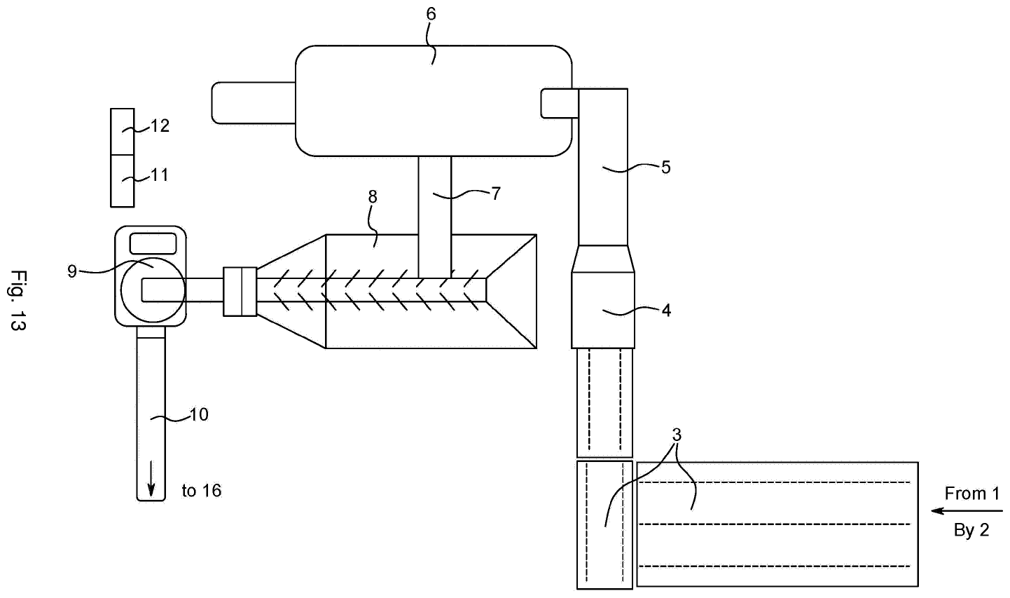

The cutting and mixing unit may operate more efficiently, when the load of biomass within the unit is controlled. Thus, advantageously, a chopper and mixer includes feedstock control means, such as a silage tiller, adapted to control the feed into the cutting and mixing unit, as illustrated in FIGS. 11-12 as element 5.

In an embodiment of the invention, the system further comprises a second transport unit 5 configured for transporting the harvested biomass to the cutting and mixing unit. In an embodiment of the invention, the cutting and mixing unit is in fluid communication with a second transport unit 5 adapted as a feedstock control means, such as a feeder unit or a silage tiller. Optionally the second transport unit is a band conveyor with an inclination between 0-45 degrees, more preferably between 10-30 degrees, and most preferably between 15-20 degrees.

### First Transport Unit

The cut and mixed product is transferred from the cutting and mixing unit to the grinder unit, via the first transport unit. To obtain an efficient and clean transfer with minimum wasted material, it is advantageous that the first transport unit is of a conveyor type, such as a conveyor selected from the group of: screw-, chain-, flight-, and pneumatic conveyors, and more preferably is a screw conveyor.

In an embodiment of the invention, the first transport unit is a conveyor, preferably selected from the group of: screw-, chain-, flight-, and pneumatic conveyors, and more preferably is a screw conveyor.

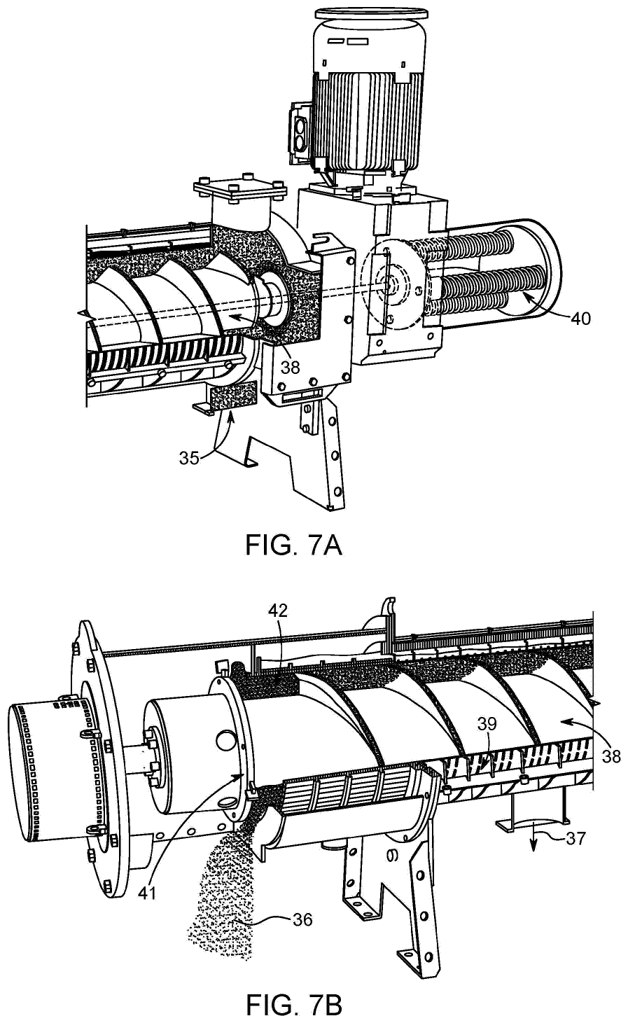

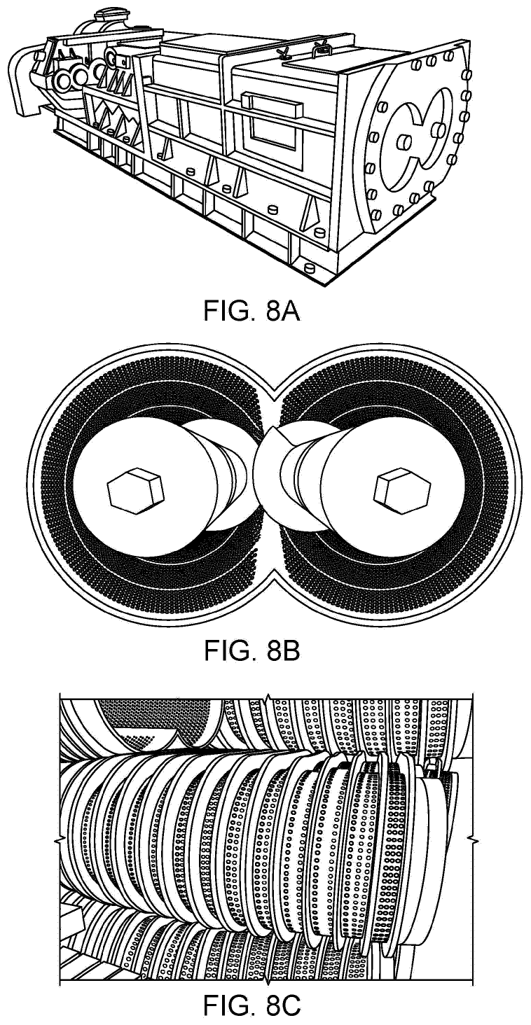

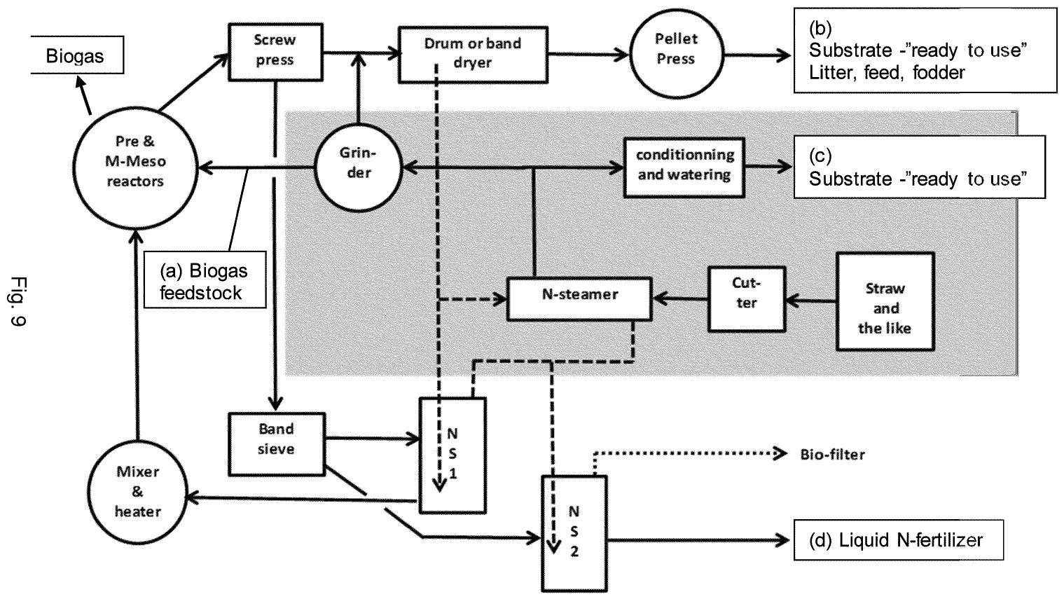

Optionally, the first transport unit is a screw conveyor, and optionally the screw conveyor is further configured for separating solid and liquid biomass during the transport of the biomass as exemplified in FIGS. 7 and 8. The screw conveyors illustrated in FIGS. 7-8 are further described in the section “moveable system for grass”.

FIG. 7A shows the part of the screw conveyor where biomass is fed from the cutting and mixing unit and into the first transport unit, i.e. biomass inlet 35. FIG. 7B shows the part of the conveyor where the transported biomass may exit the transport unit, either as solid matter from biomass solid outlet 36, and/or as liquid from biomass liquid outlet 37.

In some embodiments, it is advantageous that the screw conveyor is configured to separate solid and liquid biomass during the transport of the biomass, thereby improving the efficiency of the system, and the utilization degree of the original raw harvested biomass. The solid biomass exiting the first transport unit, may be further treated in a grinder unit, whereas the liquid biomass may be used in a biogas plant.

In an embodiment of the invention, the first transport unit is configured to separate solid and liquid biomass during the transport of the biomass.

FIG. 7B shows how the separation may be efficiently carried out by a mechanical process. The screw snail 38 is seen to rotate within an outer tube, wherein a grid or mesh 39 is placed in a concentric distance from the tube wall. Thus, as the biomass feedstock is transported by the screw snail, the liquid part of the biomass will be able to exit through the mesh and subsequently the liquid outlet 37, while the solid part of the biomass is transferred to the end channel 42, defined by a disc 41 at the end. The solid biomass may exit the transport unit through the solid outlet 36, where the outlet may be generated by displacing the disc 41 in the axial direction of the rotation axis. The axial displacement may be obtained by pressure means 40 placed at the opposite end of the transport unit as illustrated in FIG. 7A. The pressure means may be manually or pneumatically operated.

### Grinder Unit

The grinder unit is configured to produce a grinded product, i.e. small and uniform pieces that are suitable for storage, conversion into biofuel, and/or conversion into biomass products. Examples of a grinded biomass product include crushed wood chips, wood shavings, sawdust and other lumpy biomass, as illustrated in FIG. 3. Thus, the grinded product will have a second uniform size that is smaller than the first uniform size of the biomass obtained after the cutting and mixing step. The second uniform size further implies that the grinded product facilitates a different packing degree of the grinded pieces, compared to the packing degree of the biomass after cutting and mixing.

A grinded biomass product may further be optimal for conversion into biofuel and biomass products, such as a plant growth media. Due to the uniform and small size of the grinded product, the pieces will be volumetrically packed in a certain degree and with an exposed surface area making it ideal for chemical treatment and conversion. When biomass is used as feed stock in a biogas plant, it is essential that the biomass has a size and shape that facilitate the chemical conversion of the biomass to biofuel. For example, it may be essential that the biomass feed stock have a small and uniform size, and is compacted in such a degree that the surface area of the feed stock is sufficiently exposed for the chemical reactions to occur. For example, converting biomass to biogas and substrates for plants involves the chemical processing step of treating the biomass with a steam comprising nitrogen to separate the fermentable sugars from the lignin within the biomass. The efficiency of the nitrogen steaming process will thus depend on the contact time and degree of contact surface between the steam and the biomass. The contact surface will depend on the size and shape (and thus inherently the surface area of the biomass) as well as the compaction degree (i.e. the access of the steam to the surface of the biomass).

The size, shape, and compaction degree of the resulting grinded biomass material will depend on the type of grinder apparatus. Conventionally, a hammermill is used to produce a grinded biomass suitable for nitrogen steaming, such as to convert straw into a biogas substrate.

In a hammermill, dry biomass is fed to the mill chamber, where it is struck by ganged hammers attached to a shaft that rotates at high speed inside the grinding chamber. The biomass material is then crushed and shattered to a reduced size by the hammer impacts and collisions with the grinding chamber walls. The discharge opening of the grinding chamber may be a screen with a defined mesh size, such that material with sizes below will be allowed to pass and be discharged, and coarser material will be further grinded.

However, the operational principle of a hammermill implies that for the hammermill to operate efficiently, it is essential that the biomass is dry. Moist or wet biomass will cause the grinding process to be inefficient and/or clogging of the hammermill.

The inventors surprisingly found that a grinder unit according to the present invention may replace a hammermill, when processing biomass to a size appropriate for chemical processing, particularly nitrogen steaming. Particularly it was seen that the system comprising the grinder unit according to the present invention may result in a grinded biomass with size, shape, and compaction degree resulting in a further improved efficiency of the nitrogen steaming process. For example, the grinder unit according to the present invention in combination with N-steaming of straw were seen to result in an increased biogas yield of 45-60 m3 CH₄ per 1000 kg, corresponding to 55-70 m3 CH₄ per 1000 kg dry matter.

It was further seen that the grinder unit according to the present invention resulting in a more efficient grinding process, and in particular, comparable or more efficient grinding was obtained on wet or moist biomass. Thus, grinded biomass with size, shape, and compaction degree suitable for a chemical vapour process, such as nitrogen steaming, may be produced from both wet or moist biomass.

An embodiment of a grinder unit according to the present invention is shown in FIG. 3. The cut and mixed biomass is entered into the top of the grinder and then crashed and pressed through the matrice by three or more rotating koller heads/wheels. Thus, the size and shape of the grinded product exiting the grinding unit will depend on the wheels as well as the matrice properties, and especially the shape and size of the holes, or openings, in the matrice.

In an embodiment of the invention, the grinder unit is not a hammermill. In another embodiment, the grinder unit is configured to operate on moist or wet biomass.

In a further embodiment, the grinder unit comprises two or more rotating wheels configured for cutting biomass, preferably comprising three rotating wheels, and a matrix comprising multiple openings configured for transferring grinded biomass with a size below the size of the openings. Thus, grinded biomass may be transferred through the openings, and thereby discharged or emitted out of the grinder unit. In a further embodiment, the openings have a diameter between 1 to 40 mm, more preferably between 6 to 24 mm, and most preferably between 12 to 16 mm.

### Systems

The grinded product may be transferred away from the grinder unit via a third transport unit 10 as indicated in FIG. 1. Similar to the first and/or second transport unit, the third transport unit may advantageously be of a conveyor type. The third transport unit facilitates that the grinded product may be unloaded at any location.

In an embodiment of the invention, the system further comprises a third transport unit 10, such as a conveyor, configured for transferring the grinded biomass from the outlet of the grinder unit.

The system according to the invention comprising the cutting and mixing unit, the first transport unit, and the grinder unit, may be stationary and e.g. connected directly to a nitrogen steaming plant. The system may further be stationary and connected to a storage configured to directly provide biomass to a nitrogen steaming plant, such as a walking floor container in fluid communication with a biogas plant.

Alternatively, the system according to the invention is a mobile, or moveable, and separate system from the nitrogen steaming plant, which may be detachably connected to one or more nitrogen steaming plant(s) or one or more storage(s) connected to the nitrogen steaming plant.

In an embodiment of the invention, the system is configured to be mobile, moveable, or stationary.

FIG. 2 shows an embodiment of a mobile, or moveable, system 100, shown in a cross-sectional view. The cutting and mixing unit 6 is in fluid communication with the grinder unit 9 via a first transport unit 7.

Optionally, as indicated in FIG. 2, the first transport unit is a conveyor with an inclination between 0-90 degrees, more preferably between 10-45 degrees, and most preferably between 25-35 degrees.

The mobile system may be operated by one person, where the person feeds the cutting and mixing unit with biomass. The system 100 unit may further comprise a control panel (SRO), a power unit, such as a motor generator, with a capacity of circa 200 kW and a tractor with 150 HP on diesel or preferably on biomethane or a mix of biomethane and diesel.

The movable system may be operated by one person per shift and with a capacity of 3.5 ton dry matter per hour in operation.

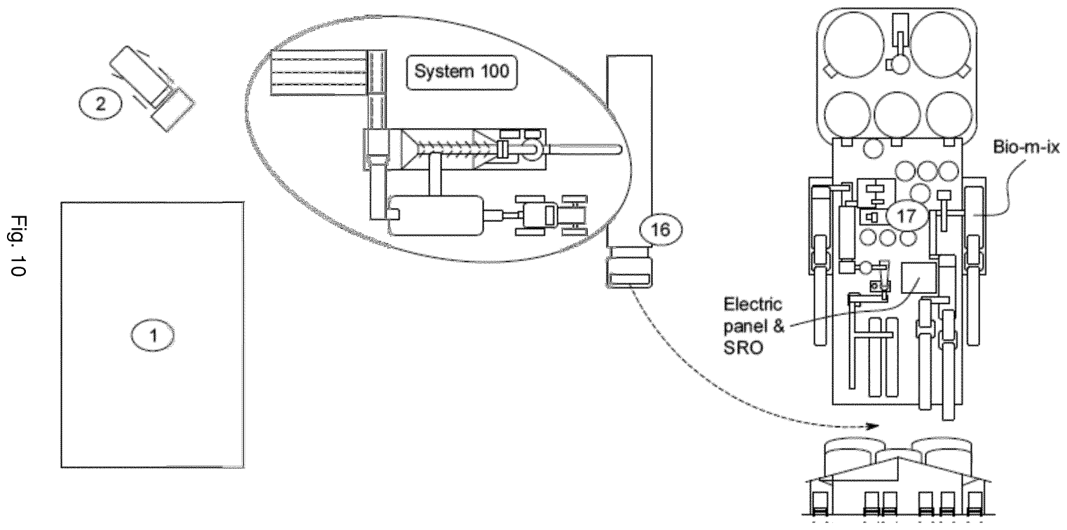

FIG. 9 shows an embodiment of a biogas plant. The grinded product from e.g. a mobile or stationary system according to the invention is transferred to the nitrogen steamer unit (indicated as “N-steamer” in FIG. 9). The nitrogen steamer may optionally be operated using the warm and moist steam comprising nitrogen from a nitrogen stripper unit, and/or separation- or drying unit. From the nitrogen steamer, the grinded and steamed material may be fed to a biogas reactor.

Optionally, other sources of biomass may be added to the grinded product before being introduced into the N-steamer. Examples of other sources of biomass include: agricultural waste such as grass silage, animal waste such as deep litter from e.g. poultry, cattle, and horses, as well as organic or eco-friendly biomass, such as rice straw, elephant grass, e.g. pennisetum purpureum, saccharum ravennae, miscanthus fuscus, and biomass from willow trees.

A mobile, moveable, or stationary system, advantageously comprises one or more of the following elements, to facilitate the operation: a buffer and feeder unit 8, a control unit 11, a power supply unit 12, a feeder unit 3, and an eliminator unit 4.

The buffer and feeder unit is advantageously configured for controlling the supply and transfer of the biomass from the cutter and mixer unit to the grinder unit. For more efficient operation of the grinder, the load of biomass within the grinder is advantageously controlled. Similarly, the cutting and mixing unit is operating more efficiently if the load within the unit is controlled, and the amount of other materials, such as ropes, from e.g. the bales, or stones are minimized. Thus, advantageously, the system comprises one or more eliminator unit(s), configured for separating the biomass from other materials, such as rope, stone, metal, and other heavy particles. Advantageously, the buffer and feeder unit is connected with an eliminator unit, and further advantageously the second transport unit is connected with an eliminator unit. For example, the buffer and feeder unit advantageously is fluidly connected with an eliminator unit, such that stone, rope and other heavy particles are removed before entering the grinder. The eliminator may for example be mounted at the top of the buffer and feeder unit, and be a top-mounted eliminator.

In an embodiment of the invention, the system comprises a buffer and feeder unit 8 configured for supplying the biomass to the grinder unit. In a further embodiment, the system further comprises a control unit 11, such as a a panel or a SRO. In a further embodiment, the system further comprises a power supply unit 12, such as a motor-generated plant or a tractor.

In a further embodiment, the system further comprises a feeder unit 3 configured for transferring straw in bales or loose. In a further embodiment, the system further comprises an eliminator unit 4 configured for separating the biomass from other materials, such as rope and stones, metal and other heavy particles. In a further embodiment, the system comprises multiple eliminator units.

### Moveable Systems

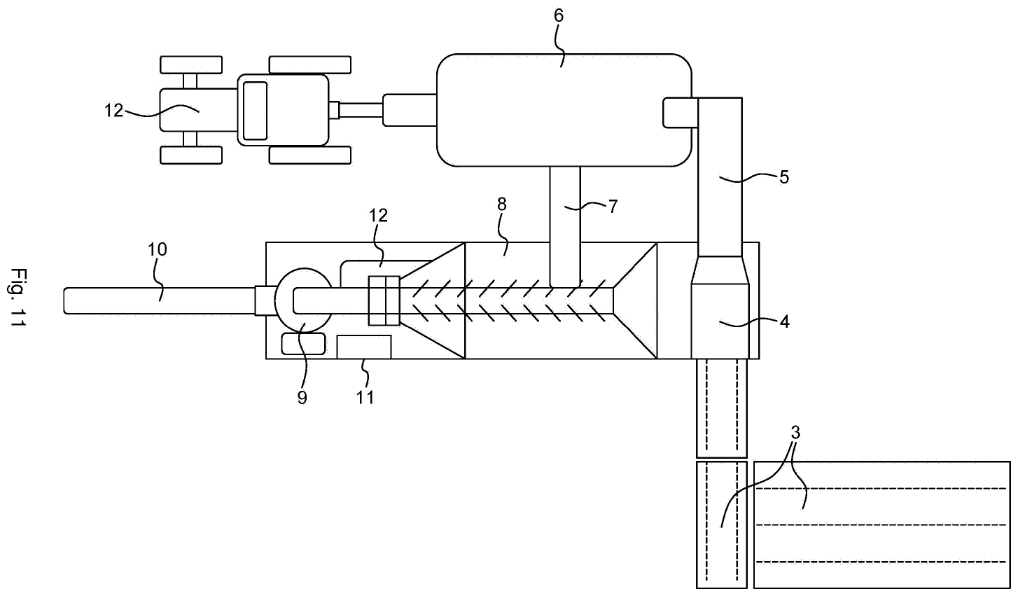

FIG. 10 shows an embodiment of a moveable system 100 for processing harvested biomass into a grinded product. In the embodiment, the harvested biomass is temporary stored 1 on e.g. a field or farm, and the operation of the mobile system, including the grinding, takes place on the location, where the harvested biomass is temporary stored 1 on e.g. the farm.

In an embodiment of FIG. 10, the harvested biomass may be straw in bales or loose. In a further embodiment, the harvested biomass is selected from the group of: straw, grass, animal biomass, and any combinations thereof. In a further embodiment, the the harvested biomass is either in a dry, wet, or moist form. In a further embodiment, the harvested biomass is organic or eco-friendly biomass, such as rice straw, elephant grass, e.g. pennisetum purpureum, saccharum ravennae, miscanthus fuscus, and biomass from willow trees.

From the temporary storage 1, the harvested biomass is moved by loader 2 and loaded into the moveable system 100. In the embodiment, the system comprises the components with reference number 3 (feeder for straw in bales or loose), 4 (eliminator for removing ropes, stones, and other heavy particles from the biomass e.g. straw), 5 (second transport unit for transporting the biomass to the cutting and mixing), 6 (cutting and mixing unit), 7 (first transport unit), 8 (buffer and feeder unit) optionally with a top-mounted eliminator for separating the biomass from other materials, such as rope and stones, metal and other heavy particles, 9 (grinder unit), 10 (third transport unit), 11 (control panel, such as SRO), and 12 (power supply, such as a motor-generator plant, or a tractor).

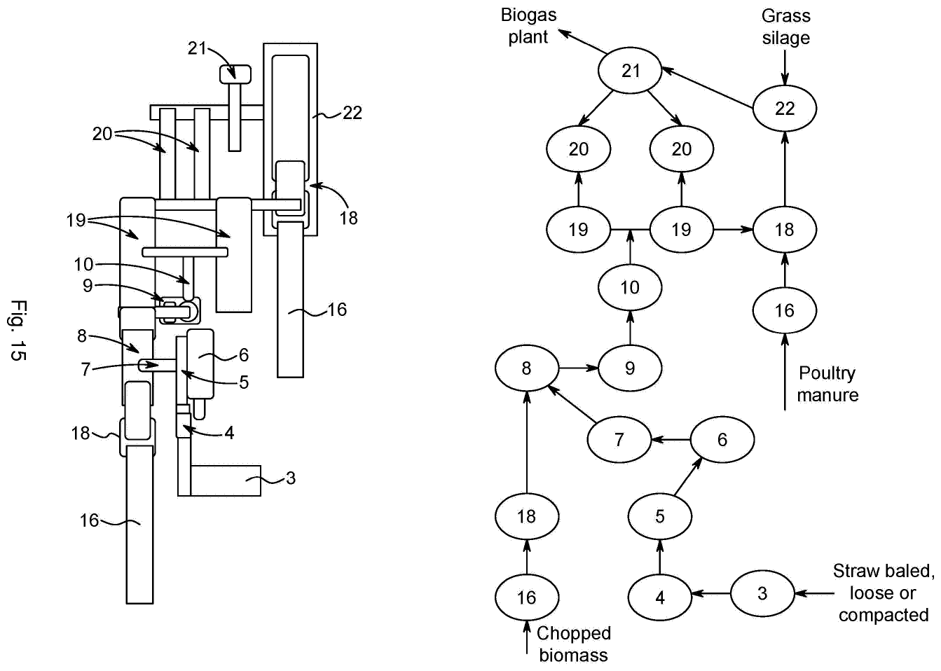

From the system 100, the grinded product may be transferred to a buffer storage and/or a transport unit 16, and e.g. transported to a biogas plant 17. An embodiment of a biogas plant comprises the elements with reference number 18 (unloader/loader unit), 19 (buffer and feeder unit), 21 (power feed), 22 (bio mixer), 23 (heater unit), 24 (separation or screw press), 25 (fiber or solid outlet), and 27 (reject liquid outlet). Preferably, the biogas plant further comprises 20 (N-steamer unit), 26 (dryer unit), 28 (water ring pumps), 29 (N-stripper unit), 30 (N-absorber unit), and 31 (compactor or pellet press unit). A detailed embodiment of a biogas plant is shown in FIG. 14.

Thus, in an embodiment the grinded biomass is compacted and stored on location and then loaded in transport units and transported to biogas plants when needed or convenient.

A further detailed embodiment of a moveable system 100 from a top view is shown in FIG. 11. The harvested biomass crops are taken from the temporary store 1 by a loader 2 (not shown in FIG. 11), and loaded into a feeder unit 3, and fed to an eliminator unit 4, which is a device that cut and eliminate ropes, loosen the straw and eliminate stones, metal and heavy particles. The remaining loose straw is transferred or fed by the second transport unit 5 into a cutting and mixing unit 6, where the crops are cut and mixed to a more uniform size and blend. The cut and mixed product is then transferred via the first transport unit 7, into a buffer and feeder unit 8, optionally with a top-mounted eliminator for separating the biomass from other materials, such as rope and stones, metal and other heavy particles, from which it may be transferred further to the grinder unit 9, and further out of the system via a third transport unit 10. For the moveable system to operate on location, such as any place on a farm, it is further necessary that the system comprises a control unit 11, such as a panel or a SRO, and a power supply unit 12, such as a motor-generated plant or a tractor.

In an embodiment of the invention, the system is configured as a moveable system comprising: a feeder unit 3, an eliminator unit 4, a second transport unit 5, a cutting and mixing unit 6, a first transport unit 7, a buffer and feeder unit 8, a grinder unit 9, a third transport unit 10, a control unit 11, and a power supply unit 12.

Ropes, stones and heavy particles are typically not present in all types of harvested biomass, such as grass silage, fresh cut grass, and deep litter. Thus, depending on the type of harvested biomass, the feeder unit and eliminator unit may be optional. For example, grass silage, fresh cut grass, and deep litter may advantageously be loaded directly into the cutting and mixing unit 6 via a second transport unit 5.

In a preferred embodiment of the invention, the system is configured as a moveable system comprising: a second transport unit 5, a cutting and mixing unit 6, a first transport unit 7, a buffer and feeder unit 8, a grinder unit 9, a third transport unit 10, a control unit 11, and a power supply unit 12.

FIG. 12 shows an embodiment of the moveable system 100 from a side view, or in profile. In the embodiment, the feeder unit 3 is exemplified as two conveyors in communication, where the harvested biomass or harvest units are placed on the first conveyor by a loader, and the second conveyor feed the bales into the eliminator unit 4.

In an embodiment of the invention, the eliminator unit 4 is divided into 3 sections, where the first section is configured for cutting and eliminating the ropes e.g. by means of cutters, the second section is configured for loosen the straw e.g. by means of rotators, and the third section is configured for separating stones, metal, and heavy particles from the loosen straw by e.g. magnet means and/or air flow, e.g. by blowing the straw into the second transport unit 5.

In an embodiment of the invention, the eliminator unit comprises one or more sections, and wherein at least one section comprises magnetic means or means for providing an air flow means.

In an embodiment of the invention, the second transport unit 5 is a band conveyor with an inclination between 0-45 degrees, more preferably between 10-30 degrees, and most preferably between 15-20 degrees.

In an embodiment of the invention, the cutting and mixing unit 6 is a tractor driven fodder mixer wagon, similar to a wagon typically used on bigger cattle farms and exemplified in FIG. 6. The chopper and mixer is conventionally used for forages, such as straw and coarse fodder for dairy cows, fattening cattle, and sheep-and-goat livestock, as well as other types of fibrous products. The coarse fodder may for example include: beets, silage, and baled or loose straw. Other types of dry or wet forages may also be processed within the cutting and mixing unit, these include: maize, grass silages, and other types of feed stuck. Other types of dry or wet plants may also be processed, such as organic or eco-friendly biomass, such as rice straw, elephant grass, e.g. pennisetum purpureum, saccharum ravennae, miscanthus fuscus, and biomass from willow trees. The exemplified chopper and mixer is from the Italian company SEKO, and is a Chopping-Mixing-Wagon from the Samurai 5 series. FIG. 6 shows in more details the chopping and mixing devices that are used by SEKO.

The moveable system according to the present invention, advantageously has dimensions making it suitable for processing high volumes of harvested biomass, and at the same time has dimensions making the system easy to be moved around and used for transport over potentially long distances. Advantageously, a chopper and mixer has a volume capacity between 1 to 50 m³, more preferably between 3 to 40 m³, or 10 to 20 m³, and most preferably is from 5 to 30 or 5 to 33 m³. Thus, advantageously, a chopper and mixer has a volume capacity from 5 to 30, or 5 to 33 m³.

In an embodiment of the invention, the moveable system comprises a chopper and mixer unit with a volumen capacity between 5 to 30, or 5 to 33 m³. In a further embodiment of the invention, the system is adapted for mobile and/or self-propelled or trailed operation. In another embodiment, the system is adapted for stationary operation.

In the embodiment shown in FIG. 12, the cut and mixed biomass is transferred to a buffer and feeder unit 8, by a first transport unit 7. Advantageously, the first transport unit is of a conveyor type, such as a conveyor selected from the group of: screw-, chain-, band or pneumatic conveyors, and more preferably is a band conveyor. Further advantageously, the first transport unit 7 has an inclination between 0-90 degrees, more preferably between 10-45 degrees, and most preferably between 25-35 degrees.

The buffer and feeder unit 8 is feeding the cut and mixed biomass in desired amounts into the grinder unit 9.

FIG. 3 shows an embodiment of a grinder unit 9. In the grinder unit 9 the biomass is broken down into smaller and uniform size. This facilitates that the biomass may be further compacted to have an exposed surface area, which is optimal for the further chemical processing step to convert the biomass.

From the grinder 9 the grinded biomass is fed into a buffer storage and/or transport unit 16 by the third transport unit 10, as illustrated in FIGS. 10 and 12.

Advantageously, the third transport unit is of a conveyor type, such as a conveyor selected from the group of: screw-, chain-, band or pneumatic conveyors, and more preferably is a band conveyor. Further advantageously, the third transport unit 10 has an inclination between 0-90 degrees, more preferably between 10-45 degrees, and most preferably between 25-35 degrees.

The buffer storage and transport unit 16 may be any type of place suitable for storage and/or transport. In an embodiment, the buffer storage and transport unit 16 is selected from the group of: tip wagon, container, and truck trailer, such as a truck trailer equipped with walking floor.

For the moveable system to be operated at any place, the system 100 further advantageously comprises a control unit, such as a panel (SRO) 11, and a power unit 12. Advantageously, the power unit is adapted to the volumes of biomass that need to be processed. For example, the power unit may have a capacity of circa 200 kW, which may be obtained from a tractor with 150 HP on diesel or preferably on biogas, biomethane, or any mixtures thereof, such as a mix of biogas and diesel, or a mix of biomethane and diesel.

In an embodiment of the invention, the total power needed corresponds to 42 kWh per 1000 kg dry matter in the biomass to be treated. The capacity on a movable system 100 according to the present invention may be in the range of 3 to 4 ton of dry matter per hour, or 3 to 6 ton of dry matter per hour.

In an embodiment of the invention, the power supply unit has a capacity between 100 to 500 kW, more preferably from 200 kW to 350 kW. In a further embodiment, the power supply unit is configured to generate between 20 to 60 kWh per 1000 kg harvested biomass, more preferably between 30 to 50 kWh, such as 42 kWh.

The movable system 100 may be operated by one person, where the person by use of loader tractor 2 feeds the feeder unit 3 with harvest units. In this case straw with 4500 ton dry matter can be treated within 1500 operation hours. The mobile system may also be operated by two persons, whereby straw with 9000 ton of dry matter may be treated within 3000 hours operation.

System in Combination with a Biogas Plant

Converting biomass to a substrate for biogas involves the chemical processing step of treating the biomass with a steam comprising nitrogen to separate the fermentable sugars from the lignin within the biomass. The efficiency of the nitrogen steaming process will thus depend on the contact time and degree of contact surface between the steam and the biomass. The contact surface will depend on the size and shape (and thus inherently the surface area of the biomass) as well as the compaction degree (i.e. the access of the steam to the surface of the biomass).

As shown in FIG. 10, the grinded biomass may be transferred from the buffer storage and transport unit 16 to a biogas plant 17, where the grinded biomass is unloaded in unloader/loader units 18 and loaded into a buffer and feeder unit 19 as illustrated in FIG. 14.

FIG. 14 shows an embodiment of a mobile, or moveable, system 100 in fluid communication with one or more biogas plants 17. From the buffer store and transport unit 16 the grinded biomass is by use of the unloader/loader unit 18 loaded in buffer and feeder unit 19. From here it is fed in to the N-steamer 20 that in parallel is supplied with N-steam from the dryer 26 and the N-stripper 29. From the N-steamer, the steamed material may be fed to a biogas plant 17 in parallel with other biomass that is taken in via bio-mixer 22 and power feed 21.

As also shown in FIG. 14, the nitrogen steaming unit may be fed with biomass from one or more storages, such as the buffer storage and transport unit 16 in fluid communication with the movable system 100 unit, and a second buffer storage and transport unit 16 comprising other sources of grinded biomass that may further be added to the bio-mixer 22 and from there via the power feed 21 added to the biogas plant 17.

### Stationary Systems

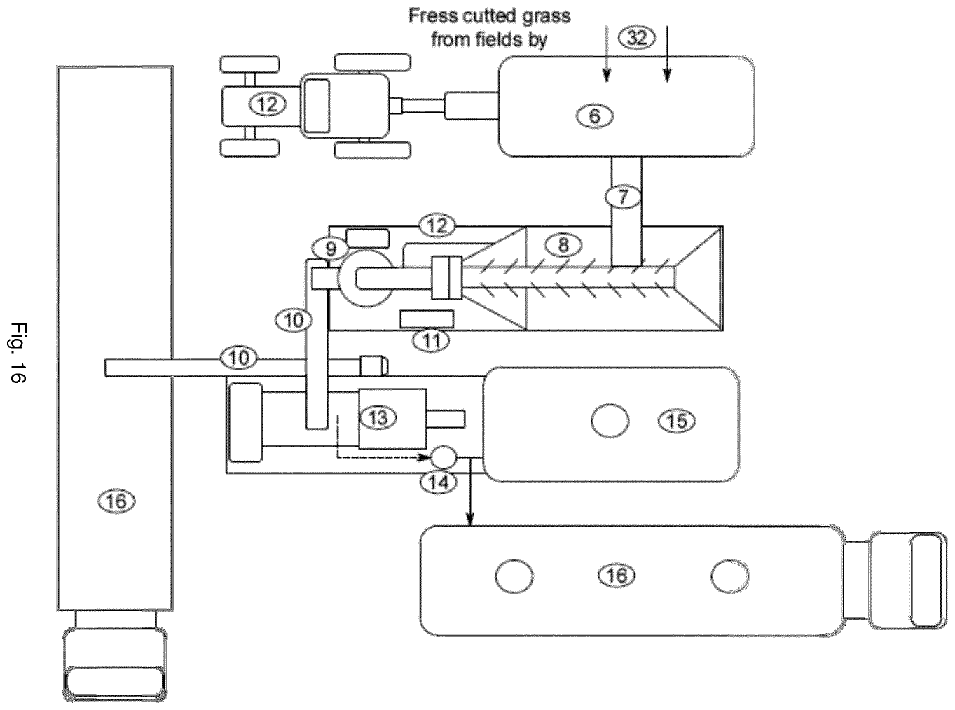

In an alternative embodiment of the invention, the system 100 may be a stationary unit, optionally directly connected to a biogas plant 17. In this case, the third transport unit 10 load the grinded biomass directly into the buffer and feeder unit 19 as shown in FIG. 15. In this case, the power supply 12 can be either directly or a separate motor-generator plant on biogas.

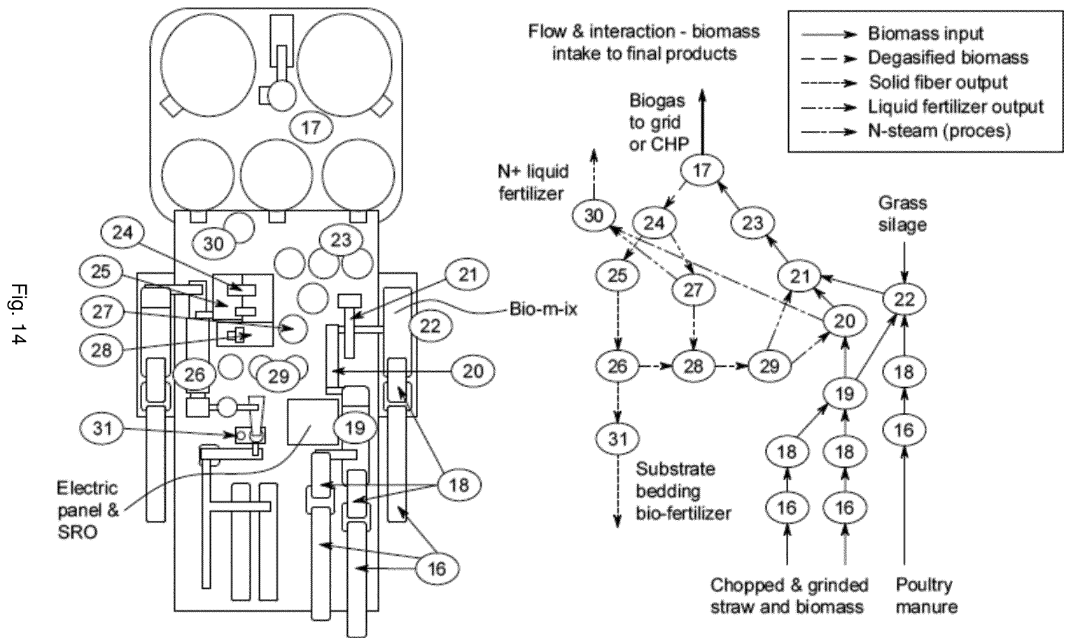

FIG. 13 shows an embodiment of a stationary system 100 according to the present invention, and the components comprised within the system and the interaction between them.

The capacity of a stationary unit may be 5 ton dry matter per hour or more, such as between 5 to 10 ton dry matter per hour.

Advantageously, the components may be adapted to the stationary system. For example, advantageously, the cutting and mixing unit 6 for a stationary system and plant is comparable to the unit exemplified in FIG. 6.

### Moveable System for Grass

The moveable system according to the present invention may be particularly suitable for processing fresh grass into grass juice for green protein production. FIG. 16 shows an embodiment of the invention adapted for processing fresh grass into grass juice for green protein production. The grass is collected and grinded in a similar manner as illustrated in FIG. 11, and subsequently transferred to a screw press to produce the extract of protein liquid.

The movable system 100 is used for extracting juice for green protein from grass as illustrated in FIG. 16. Advantageously the system is placed in the field, and the extract produced decentral in the field. The extract is subsequently transported to a protein plant 33, and the residual green mass cake may be transported to a feed stuff plant 34 or biogas plants 17.

As shown in FIG. 16, the grass is collected fresh from field by tractor driven or self-propelled units that is well known equipment for harvesting green mass for silage. The fresh collected grass is added directly to the grinder unit 9 via the cutting and mixing unit 6. The grinded grass is then led to a screw press 13 where the juice is pressed out, collected and by pump 14 led to temporary store for grass juice 15 and from there by road tanker transported to the grass juice processing plant (green protein) 33. The press cake is led directly by the screw press 13 to a screw or band conveyor/transport unit 10 and loaded in buffer storage and transport units 16 and transferred to feed stuff plant 34 or biogas plants 17.

Advantageously, the system comprises one or more eliminator unit(s), configured for separating the grass from other materials, such as rope, stone, metal, and other heavy particles. Advantagously, the buffer and feeder unit is connected with an eliminator unit. For example, the buffer and feeder unit advantageously is fluidly connected with an eliminator unit, such that stone, rope and other heavy particles are removed before entering the grinder. The eliminator may for example be mounted at the top of the buffer and feeder unit, and be a top-mounted eliminator.

In a preferred embodiment of the disclosure, the buffer and feeder unit 8 comprises a top-mounted eliminator for separating the biomass from other materials, such as rope and stones, metal and other heavy particles.

FIG. 7 shows a more detailed embodiment of a single screw press 13 and FIG. 8 shows an embodiment of a twin screw press 13.

FIG. 7 shows a single screw press for separation of fresh cuttet grass, grinded grass, or other types of biomass into a liquid fraction, or juice fraction, and a fiber fraction, or press cake fraction. (A) shows the part of the screw press where biomass is fed in from the grinder unit and (B) shows the part of the screw press where the fiber or press cake exit the screw press unit with a dry matter content of up to 35%.

FIG. 8 shows a twin screw press for separation of fresh cuttet grass, grinded grass, or other types of biomass into a liquid fraction or juice and a fiber fraction or press cake. (A) shows a twin screw press unit seen from outside, (B) shows the two screws having opposite rotation directions, where one is turning left and the other is turning right, and (C) shows the filter with holes for elimation of the juice. The twin screw press facilitates that the fiber or press cake exit the twin screw press unit with a dry matter content of up to 50 wt %.

In a preferred embodiment, the mobile or moveable system is used for extracting green protein from grass. Advantageously the system is placed in the field, and the extract produced decentrally in the field. The extract is subsequently transported to a protein plant, and the residual green mass may be transported to a green pellet plant or a biogas plant.

Thus, for processing harvested grass to grass juice for green protein production, it is advantageous that the third transport unit 10 is configured to separate the liquid juice from the solid remains. This may be obtained by the third transport unit comprising, or consisting of, a screw press, such as a single screw press or a twin screw press.

In an embodiment of the invention, the third transport unit 10 is configured to separate solid and liquid biomass during the transport of the biomass. In a further embodiment, the third transport unit 10 comprises a screw press 13 configured for separating the grinded product into a liquid and solid product. In a further embodiment, the screw press is selected from the group of: single screw press, twin screw press, and combinations thereof.

### REFERENCE NUMBERS

1—temporary store for baled, loose or compacted biomass
2—loader
3—feeder for straw in bales, loose or compacted
4—eliminator—ropes, stones, metal and heavy particles
5—second transport unit
6—cutting and mixing unit
7—first transport unit
8—buffer and feeder unit
9—grinder unit
10—third transport unit
11—control panel (SRO)
12—power supply/motor-generator plant/tractor
13—screw press
14—pump
15—temporary store for grass juice
16—buffer storage and transport unit
17—biogas plant
18—unloader/loader unit
19—buffer and feeder unit
20—N-steamer unit
21—power feed
22—bio mixer
23—heater unit
24—separation/screw press
25—fiber/solid outlet
26—dryer unit
27—reject liquid outlet
28—water ring pumps
29—N-stripper
30—N-absorber
31—compactor/pellet press
32—green harvester and collector wagon
33—grass juice processing plant (green protein)
34—feed stuff plant
35—biomass inlet
36—biomass solid outlet
37—biomass liquid outlet
38—screw snail
39—mesh
40—pressure means
41—disc
42—end channel

1. A system for processing an agricultural waste biomass product into a grinded product, comprising:
a cutting and mixing unit configured for cutting and mixing harvested biomass to a first uniform size and blend,
a grinder unit configured for cutting biomass to a second uniform size,
wherein the cutting and mixing unit is in fluid communication with the grinder unit through a first transport unit configured for transporting the biomass from the cutting and mixing unit to the grinder unit, and
wherein the grinder unit comprises two or more rotating wheels, said rotating wheels having rotation axes with an angular displacement.

2. The system according to claim 1, wherein the second uniform size is smaller than the first uniform size.

3. The system according to claim 1, wherein the cutting and mixing unit comprises two rotating screws, wherein the screws are configured to rotate in opposite directions.

4. The system according to claim 1, wherein the cutting and mixing unit has a volume capacity between 1 to 50 m³.

5. The system according to claim 1, wherein the cutting and mixing unit is in fluid communication with a second transport unit adapted as a feedstock control means.

6. The system according to claim 1, wherein the first transport unit is a conveyor.

7. The system according to claim 1, wherein the grinder unit is not a hammermill.

8. The system according to claim 1, wherein the grinder unit is configured to operate on moist or wet biomass.

9. The system according to claim 1, wherein the grinder unit comprises two or more rotating wheels configured for cutting biomass, and a matrix comprising multiple openings configured for transferring grinded biomass with a size below the size of the openings.

10. The system according to claim 98 wherein the openings have a diameter between 1 to 40 mm.

11. The system according to claim 1, comprising a third transport unit, configured for transferring the grinded biomass from the outlet of the grinder unit.

12. The system according claim 1, wherein the first transport unit is a conveyor with an inclination between 0-90 degrees.

13. The system according claim 1, wherein the system is configured to be mobile, moveable, or stationary.

14. The system according to claim 1, comprising a buffer and feeder unit configured for supplying the biomass to the grinder unit.

15. (canceled)

16. (canceled)

17. (canceled)

18. (canceled)

19. The system according to claim 1, configured to be moveable and comprising a first transport unit, a buffer and feeder unit, a third transport unit, a control unit, and a power supply unit.

20. (canceled)

21. (canceled)

22. (canceled)

23. (canceled)

24. The system according to claim 1, wherein the first transport unit is configured to separate solid and liquid biomass during the transport of the biomass.

25. The system according to claim 1, wherein the third transport unit is configured to separate solid and liquid biomass during the transport of the biomass.

26. The system according to claim 25, wherein the third transport unit comprises a screw press configured for separating the grinded product into a liquid and solid product.

27. A method for processing an agricultural waste biomass product into a grinded product, comprising the steps of:
providing a harvested agricultural waste biomass,
cutting and mixing the biomass into a first uniform size and blend within a cutting and mixing unit configured for cutting and mixing harvested biomass to a first uniform size and blend,
grinding the cut and mixed biomass into a second uniform size within a grinder unit configured for cutting biomass to a second uniform size, wherein the grinder unit comprises two or more rotating wheels, said rotating wheels having rotation axes with an angular displacement,
whereby a grinded product suitable as a substrate for a biogas plant and/or as primary growth substrate for a plant, such as mushroom, and/or as substrate for producing green protein extract.

28. (canceled)

29. The method according to claims 27, wherein the agricultural waste biomass is selected from the group of: straw, grass, low quality grass silage, compromised hay, deep litter from poultry, cattle, and/or horses, leaves and smaller branches, feather from poultry, organic or eco-friendly biomass, rice straw, elephant grass, pennisetum purpureum, saccharum ravennae, miscanthus fuscus, and biomass from willow trees, and any combinations thereof.

30. (canceled)

31. (canceled)

32. (canceled)
